(19) United States
(12) Patent Application Publication
(10) Pub. No.: US 2021/0274757 A1
(43) Pub. Date: Sep. 9, 2021

(54) System and Method for Oyster Aquaculture

(71) Applicant: Robert Ballard, Tallahssee, FL (US)

(72) Inventor: Robert Ballard, Tallahssee, FL (US)

(21) Appl. No.: 16/873,673

(22) Filed: Mar. 21, 2020

Related U.S. Application Data
(60) Provisional application No. 62/821,582, filed on Mar. 21, 2019.

(51) Int. Cl. A01K 61/54; A01K 61/70

(52) U.S. Cl. CPC A01K 61/54; A01K 61/70

(57) ABSTRACT

A system and method for oyster aquaculture employs a hemispherical, dome shaped, hollow structure that is disposed in tidal or intertidal waters. This structure includes a plurality of small through-holes that allow fluid communication between the interior and exterior of the structure. An oyster seed source is suspended within the interior of the dome structure. The interior and exterior surfaces of the dome structure provide the hard surface required for the attachment of oyster spat and the resulting growth of adult oysters.

### CROSS-REFERENCES TO RELATED APPLICATIONS

This application claims priority of invention under 35 USC 119(e) from U.S. Provisional Patent Application Ser. No. 62/821,582, filed on Mar. 21, 2019

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

### 1. Field of the Invention

This invention relates to the field of submersible structures used to facilitate the creation of oyster reefs. Specifically, the present invention is a dome-shaped, hemispherical structure intended to be submerged in tidal waters and seeded with oysters to establish oyster reefs, filter water, prevent red tide, and provide wave action attenuation.

### 2. General Background

The eastern oyster, Crassostrea virginica, ranges naturally from the Gulf of Saint Lawrence in Canada to the Gulf of Mexico, the Caribbean, and the coasts of Brazil and Argentina. The eastern oyster is one of the few oyster species that can construct extensive reefs that, like corals, are primarily dead shell with a veneer of live animals.

Oysters are also unique because they are a harvestable resource and provide critical habitat. Many commercially important oyster reefs are sustained through cultch plantings and stocking seed oysters onto reefs. Early efforts at cultivation involved little more than transplanting small oysters from one area to another where they could grow faster and survive better. During the 1950's, hatchery techniques were adequately refined for commercially farmed oysters.

The eastern oyster may be found on subtidal or intertidal reefs and provides important ecological functions in estuaries throughout its geographic range. These functions are related to both the reef structure formed by oysters and the filtering activity by individual oysters. Oyster reefs support over 300 species of marine organisms that are part of the food web leading to economically important species. Oysters are capable of filtering four gallons of water per hour and are effective in reducing phytoplankton densities and improving water quality. As a result, oyster reefs are critical to maintaining species diversity and the natural production of estuaries where oyster reefs have had a dominant historical presence

Under natural conditions, oysters reproduce as water temperatures rise in the spring and continue through the fall. The temperature at which spawning occurs varies among regions. Oysters from more northern latitudes spawn at temperatures between 60 and 68 degrees F., while southern varieties spawn at temperatures of around 68 degrees F.

Eastern oysters first mature as males and sex inversion to females may occur between spawning seasons of their first year. Growth rates vary depending on temperature, with Gulf oysters attaining a 3 inch market size in as little as 15-24 months. In some locations, oyster aquaculture can produce a 3-inch oyster in 6 to 9 months.

Oyster Life Cycle
Adult Oysters: male and female oysters release eggs and sperm into the water.
Unfertilized Eggs: each adult female oyster may produce anywhere from 25-150 million eggs, depending on the size of the oyster.
Fertilized Eggs: Eggs are fertilized by sperm in the water.
Veliger: Within 12-24 hours, a veliger develops with the characteristic straight hinged, D-shape of bivalves. At this stage, the veliger larvae are capable of feeding on microscopic algae.
Pediveliger: 12-20 days post-fertilization, the oyster larva develops “eye-spot” and a “foot” and is referred o as a Pediveliger. The Pediveliger settles to the bottom and seeks out suitable substrate for setting.
Spat: Setting occurs when the larva cements itself to a hard substrate and metamorphoses into a tiny oyster called a spat. Spat may refer to any small oyster. At that point, it can never reattach or move again.

Oysters are a keystone species critical to a healthy, clean, and productive aquatic system. Oysters are filter feeders that have the ability to significantly improve water quality. However, oysters require a specific type of habitat to grow and thrive. For a variety of reasons, natural oyster beds have recently declined by about 85% around the world. Traditional oyster rich areas (like Apalachicola, Fla.) have been decimated. Reestablishing oyster beds is challenging due to the nature of the oyster breeding process. Thus, there is a need for a device and system that effectively and efficiently enables the reintroduction of oysters into an aquatic system.

### BRIEF SUMMARY OF THE INVENTION

The present invention pertains to a method and apparatus for establishing, or reestablishing, oyster reefs. The primary apparatus includes a dome shaped, hollow, hemispherical, shell-type structure designed to be submerged in tidal or intertidal waters. Preferably, a plurality of such structures are concentrated within a particular area to provide the infrastructure necessary to create or reestablish an oyster reef ecosystem.

Each structure is preferably formed from high-strength concrete, or other material suitable for long term submersion in tidal or intertidal waters. Each structure includes a plurality of openings through the structure that allow for communication of water between the interior and the exterior of the structure. Preferably, between 5-10 round openings are provided, and are randomly positioned about the structure. Alternatively, square, rectangular, oval, and other shaped openings may be provided.

Each structure further includes a removable oyster seed source holder. In one embodiment, this seed source holder is a mesh bag suspended from the upper interior of the dome structure. In another embodiment, this seed source holder is a PVC pipe with removable end caps. This PVC pipe is connected to the top portion of the structure and extends into the interior area created by the dome structure. The PVC pipe includes a plurality of openings that allow for fluid communication between the interior of the pipe and interior space of the dome structure. An effective number of live, adult oysters are placed into the seed source holder and the seed source holder is secured within the interior space of the structure.

These seed source oysters then go through a normal spawning process, during which the eggs and sperm that are released are initially within a semi-contained environment. This can significantly increase the efficiency of the spawning process. As oyster larva develop, they require a hard surface for attachment. The dome structures provide suitable hard surfaces both on the interior and the exterior of the structures. Once attached, the oyster spat develop into adult oysters. Thus, the dome structures both facilitate efficient spawning and provide the required environment for oyster growth.

In operation, a plurality of dome structures can be submerged in near proximity over a designated area in tidal or intertidal waters. These structures are then provided with live oysters which are allowed to naturally spawn. The resulting larva find attachment on the plurality of dome structures and begin the oyster reef establishment process.

### BRIEF DESCRIPTION OF THE DRAWINGS

For a more complete understanding of the present invention and the advantages thereof, reference is now made to the following description taken in conjunction with the accompanying drawings in which like reference numbers indicate like features and wherein:

FIG. 1 is a side perspective view of the oyster dome of the present invention, prior to deployment;

FIG. 2 is a side perspective view of the oyster dome of the present invention, including a cut away to show the interior surface of the oyster dome, after the oyster dome has been deployed;

FIG. 3 is a side perspective view of the oyster dome of the present invention with an oyster seed source holder;

FIG. 4 is a side perspective view of a seed source holder;

FIG. 5 is a side perspective view of a lifting mechanism used for deployment of oyster domes;

FIG. 6A is a side sectional view of the seed source and the released sperm and eggs;

FIG. 6B is a side perspective view of a mesh bag oyster seed source holder;

FIG. 6C is a side perspective view of a deployed oyster dome with movement of oyster sperm and eggs;

FIG. 7 is a side perspective view, including a cut away, to show fully developed oyster growth on the interior and exterior of the oyster dome; and

FIG. 8 is a plan view of grid of deployed oyster domes.

### REFERENCE NUMBERS INCLUDED IN THE DRAWINGS

The below table provides a ready reference for the reference numbers used in the appended drawings and in this specification:

| Ref. No. | Description | Ref. No. | Description |
|---|---|---|---|
| 100 | Oyster Dome | 101 | Through Holes |
| 102 | Rough Surface | 201 | Interior Oyster |
| 202 | Exterior Oysters | 203 | Ocean Floor |
| 300 | Seed Holder | 301 | Removable Cap |
| 302 | Holes | 401 | Screen |
| 501 | Hook | 601 | Seed Oysters |
| 602 | Sperm & Eggs | 603 | Mesh Bag |
| 604 | Wood Plug | 605 | Hanger Hook |
| 303 | Downpipe | | |

### DETAILED DESCRIPTION OF THE INVENTION THROUGH THE DRAWINGS

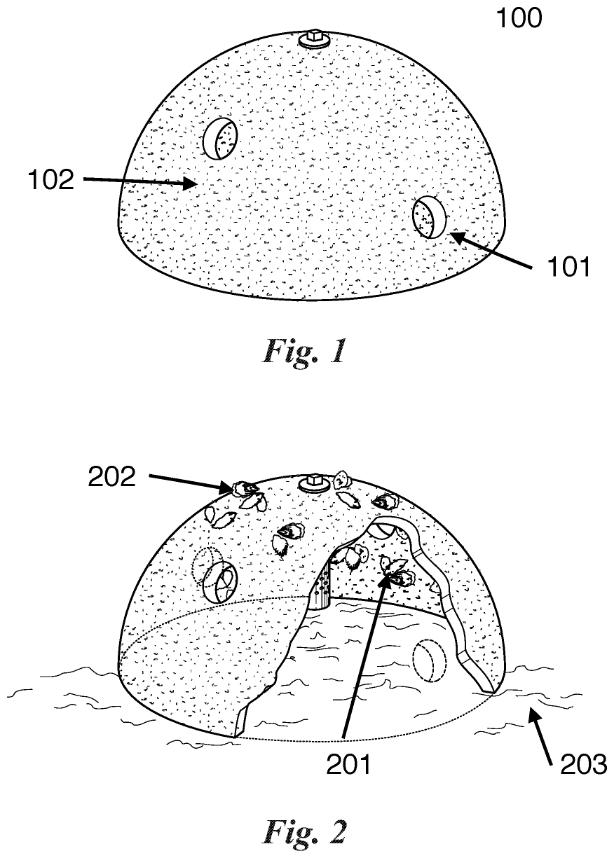

Referring to FIG. 1, oyster dome 100 is shown. Oyster dome 100 is a hemispherical, hollow, dome shaped, shell-type structure preferably constructed of high strength concrete or like cementitious material. Alternatively, oyster dome 100 may be constructed of any material suitable for long-term disposition in tidal or intertidal waters, and that provides a hard surface suitable for the attachment and growth of oyster spat. Each oyster dome 100 has a diameter of approximately 4 feet, and weighs between 400 to 450 pounds. The interior and exterior concrete surfaces of oyster dome 100 are provided with a rough surface finish 102 that promotes the attachment of interior oysters 201 (not shown) and exterior oysters 202 (not shown) to oyster dome 100. Each oyster dome 100 also includes a plurality of through holes 101 that allow fluid communication between the interior space of oyster dome 100 and the surrounding water. Preferably, each oyster dome 100 includes between 5-10 through holes 101, and each through hole 101 has a diameter of approximately 4 inches.

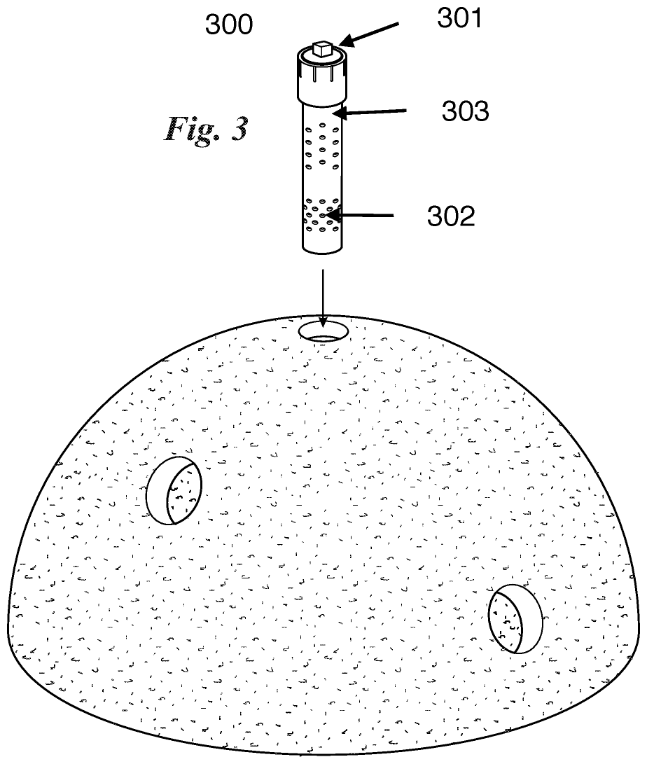

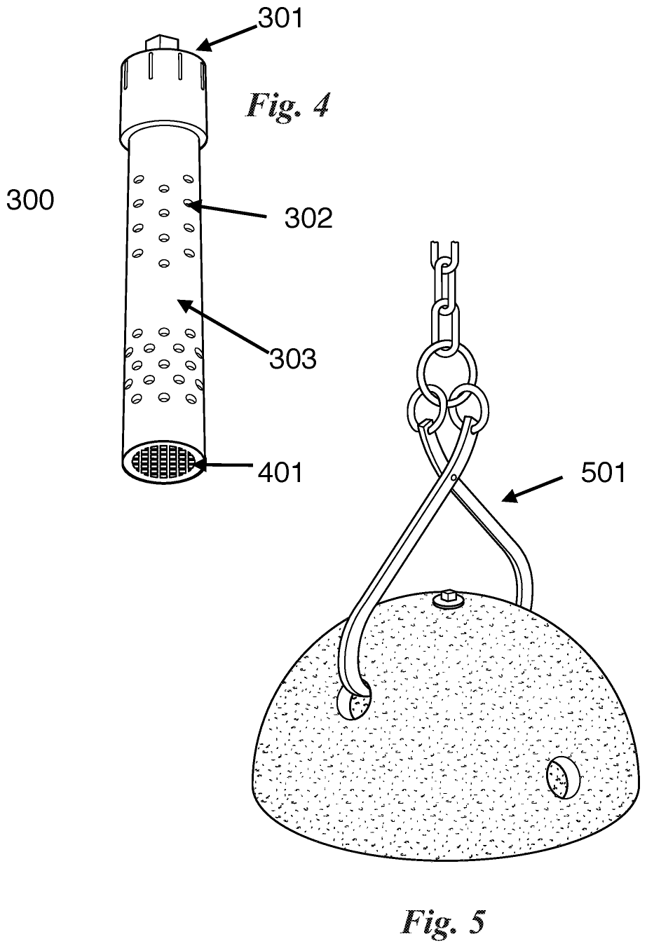

Referring to FIG. 2, oyster dome 100 is shown disposed and in contact with ocean floor 203. The beginning growth of interior oysters 201 and exterior oysters 202 is further shown. Referring to FIG. 3, seed holder 300 is shown prior to insertion into oyster dome 100. In this embodiment, seed holder 300 is constructed of a downpipe 303 that includes multiple holes 302 and a removable cap 301. In this embodiment, seed holder 300 may be constructed of PVC, similar plastic material, or other material suitable for long-term immersion in tidal or intertidal waters. Holes 302 allow fluid communication between the interior of downpipe 303 and the surrounding environment. Referring to FIG. 4, seed holder 300 further includes a screen 401 at the bottom of downpipe 303. Referring to FIG. 5, hook 501 is shown for purposes of lifting, lowering, or otherwise positioning oyster dome 100.

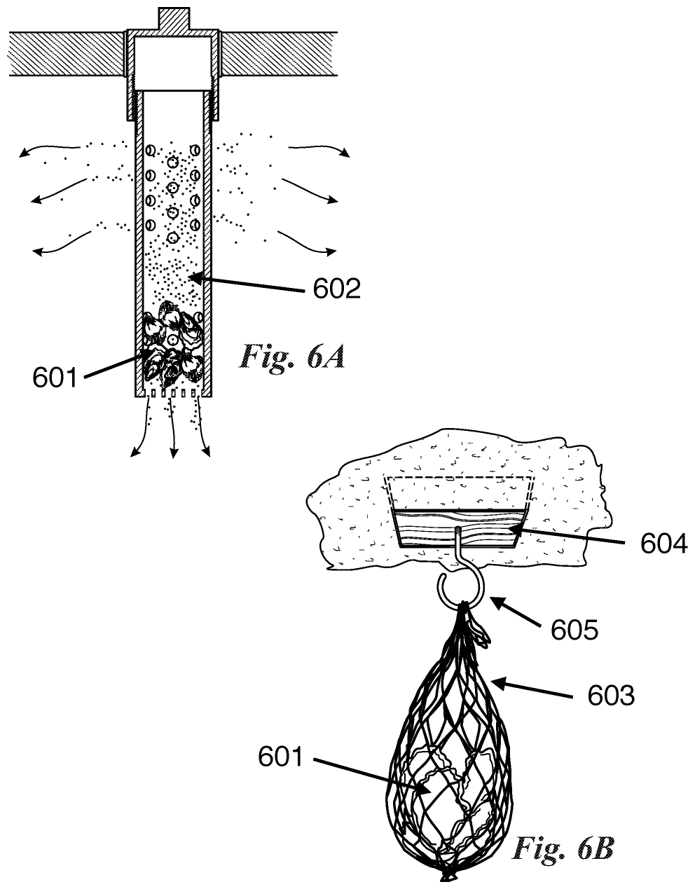

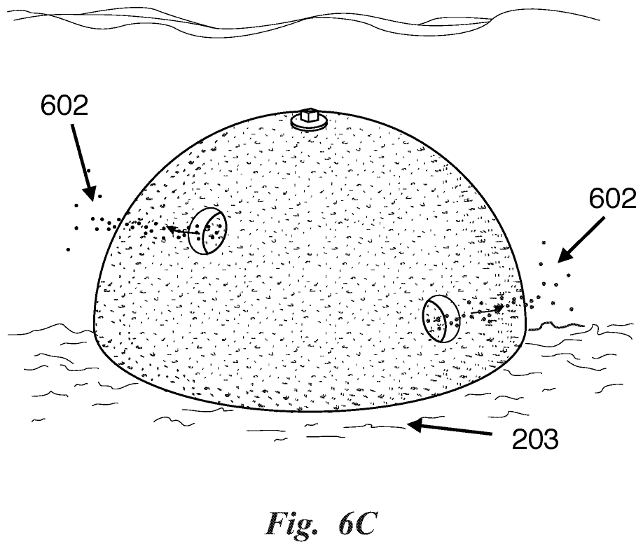

Referring to FIG. 6A, a sectional view of seed holder 300 is shown. Seed oysters 601 are shown disposed within the interior of downpipe 303. Typically, between 3 and 10 seed oysters 601 are used. When seed oysters 601 spawn, sperm and egg 602 are released. Sperm and egg 602 may then move from the interior of downpipe 303 into the interior of oyster dome 100 through holes 302 and screen 401. Referring to FIG. 6B, an alternate embodiment is shown. In this embodiment, a wood plug 605 is embedded in the top portion of oyster dome 100 (the portion where, as shown in FIG. 3, seed holder 300 is inserted into oyster dome 100), and seals an opening through the top of oyster dome 100. Hook 605 is used to secure a mesh bag 603 which contains seed oysters 601. Preferably, mesh bag 603 is formed from hemp, or some other biodegradable material.

The embodiments shown in FIGS. 6A and 6B are illustrative only. These embodiments provide a mechanism for suspending seed oysters 601 in a manner that allows fluid communication with the surrounding environment and maintains the seed oysters above any silt layer on the ocean floor. This functionality can be provided in a number of ways. For example, seed oysters could be glued or attached with hook and loop fasteners to the interior wall of the oyster dome 100; a cage containing seed oysters can be suspended from the upper portion of the interior of oyster dome 100; seed oysters can be suspended on strings hanging from the top of oyster dome 100.

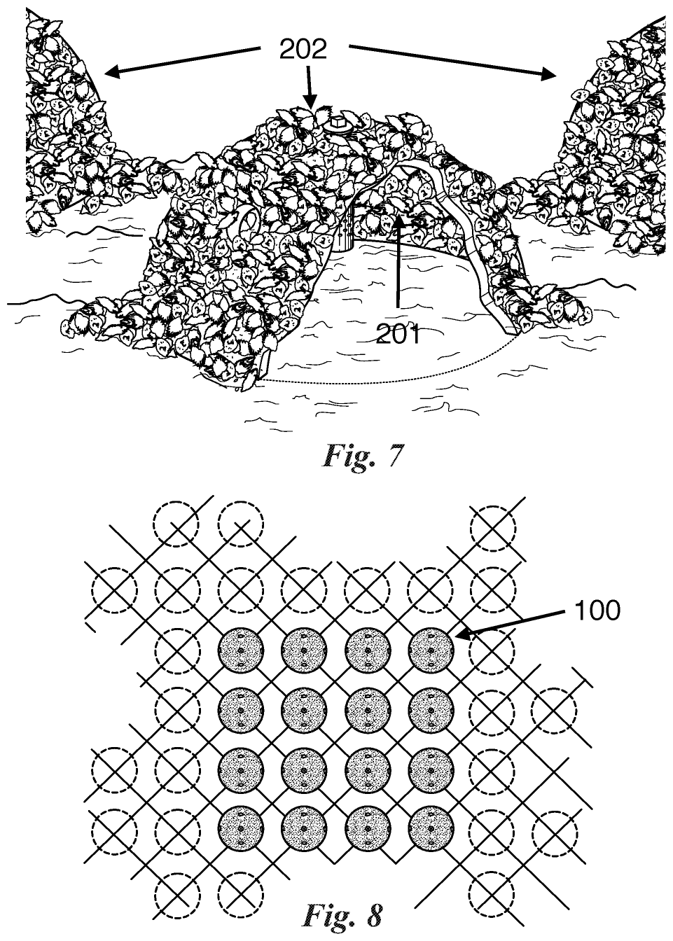

Referring to FIG. 6C, oyster dome 100 is shown disposed in tidal or intertidal waters and resting on ocean floor 203. Sperm and eggs 602 are shown migrating from the interior of oyster dome 100 into the surrounding environment. As shown in FIG. 7, over time, interior oysters 201 and exterior oysters 202 cover the interior and exterior surfaces of oyster dome 100. As seen in FIG. 8, a grid pattern of oyster domes 100 provides an efficient mechanism for creating a large area of oyster reef.

In operation, an oyster dome 100 is formed through standard concrete construction methods. Typically, through holes 101 are created as part of initial concrete construction process and are sized to be large enough to allow sufficient communication of tidal or intertidal waters but small enough to exclude large predators. Concrete is an excellent construction material as it provides the weight necessary to secure the oyster dome 100 in place (and resist wave and tidal action), it provides the hard surface oyster spat require for development into adult oysters, and it is extremely durable in aquatic environments. Because of the inherent strength in the hemispherical shape, no reinforcing steel is required.

Once placed in tidal or intertidal waters, oyster dome 100 is loaded with seed oysters 601. Seed oysters 601 are suspended within the interior of oyster dome 100. Once seed oysters spawn, the resulting sperm and eggs 602 are initially enclosed in a semi-restricted area, significantly increasing the probability of fertilization. Once fertilization occurs, oyster dome 100 provides an ideal hard surface for the resulting oyster spat to attach and grow. This oyster growth occurs on both the interior and exterior surfaces of oyster dome 100.

Because oysters are filter feeders, oysters also have the ability to significantly increase water clarity. Increasing water clarity provides additional environmental benefits such as removing harmful algae (e.g., the algae producing red tide) and allowing sufficient sunlight to reach the sea floor so that seagrasses may grow.

In one preferred implementation, as shown in FIG. 8, a grid of multiple oyster domes 100 is disposed over a tract of sea floor. Positioning multiple oyster domes 100 in close proximity to each other creates a positive feedback loop by providing both a large number of spawning oysters and a large amount of surface area suitable for oyster spat attachment and growth. A large number of oysters filters a large amount of water, thereby increasing water clarity and encouraging and enabling the growth of seagrasses. The structure provided by the oyster domes 100 and the seagrass habitat created provides a foundational environment for many aquatic species. Finally, the grid structure also provides wave attenuation and decreases the destructive force of significant weather events such as hurricanes.

Having described my invention, I claim:

1. A structure for facilitating oyster reproduction comprising:
a. a generally hemispherical shell having an outer surface and an inner surface;
b. a plurality of through-holes provided in said shell, said through-holes providing fluid communication between an interior of said shell and an exterior of said shell; and
c. means for suspending an oyster seed source suitable for the production of oyster sperm and oyster eggs in an interior of each of said shell structures.

2. The structure of claim 1 wherein said shell is constructed from a cementitious material.

3. The structure of claim 1, wherein said means for suspending an effective number of live oysters within said interior of said shell is comprised of a PVC tube.

4. The structure of claim 1, wherein said means for suspending an effective number of live oysters within said interior of said shell is comprised of a mesh bag suspended from said inner surface of said shell.

5. A method for establishing an oyster reef comprising the steps of:
a. disposing in tidal or intertidal waters a plurality of generally hemispherical shaped shell structures;
b. providing a plurality of through-holes in each of said shell structures;
c. suspending an oyster seed source suitable for the production of oyster sperm and oyster eggs in an interior of each of said shell structures;
d. providing a confined space for fertilization of said oyster eggs;
e. providing a hard surface for attachment of said fertilized oyster eggs;
f. allowing said fertilized oyster eggs to develop into adult oysters;
g. allowing said adult oysters to continue creating additional oyster sperm and oyster eggs;
whereby, an effective number of adult oysters are created and attached to said plurality of shell structures to create said oyster reef.

6. A method for treating red tide comprising the steps of:
a. disposing in tidal or intertidal waters a plurality of generally hemispherical shaped shell structures;
b. providing a plurality of through-holes in each of said shell structures;
c. suspending an oyster seed source suitable for the production of oyster sperm and oyster eggs in an interior of each of said shell structures;
d. providing a confined space for fertilization of said oyster eggs;
e. providing a hard surface for attachment of said fertilized oyster eggs;
f. allowing said fertilized oyster eggs to develop into adult oysters;
g. allowing said adult oysters to continue creating additional oyster sperm and oyster eggs;
whereby, an effective number of adult oysters are created to filter sufficient water to treat red tide.
